(19) United States
(12) Patent Application Publication
(10) Pub. No.: US 2026/0213073 A1
(43) Pub. Date: Jul. 23, 2026

(54) MULTILAYER ELECTRONIC COMPONENT

(71) Applicant: SAMSUNG ELECTRO-MECHANICS CO., LTD., Suwon-si (KR)

(72) Inventors: Jin Il KANG, Suwon-si (KR); Sang Yeop KIM, Suwon-si (KR); Ji Hun LEE, Suwon-si (KR); Hyun Goo JEONG, Suwon-si (KR)

(73) Assignee: SAMSUNG ELECTRO-MECHANICS CO., LTD., Suwon-si (KR)

(21) Appl. No.: 19/398,958

(22) Filed: Nov. 24, 2025

(30) Foreign Application Priority Data
Jan. 22, 2025 (KR) 10-2025-0009608
Apr. 21, 2025 (KR) 10-2025-0051308

(51) Int. Cl. H01G 4/224; H01G 4/012; H01G 4/12; H01G 4/30

(52) U.S. Cl. CPC H01G 4/224; H01G 4/012; H01G 4/12; H01G 4/30

(57) ABSTRACT

A multilayer electronic component includes a body including a capacitance formation portion including a dielectric layer and internal electrodes arranged alternately with the dielectric layer in a thickness direction and a cover portion disposed above and below the capacitance formation portion in the thickness direction and an external electrode disposed on the body. The cover portion includes an inner cover portion and an outer cover portion. When an average value of a major axis length and a minor axis length of grains is defined as the grain size, a grain having a grain size of 500 nm or less is a first grain, and a grain having a grain size of 1150 nm or more is a second grain, the inner cover portion includes a plurality of first grains, and the outer cover portion includes a plurality of first grains and a plurality of second grains.

### CROSS-REFERENCE TO RELATED APPLICATION(S)

This application claims benefit of priority to Korean Patent Application Nos. 10-2025-0009608 filed on Jan. 22, 2025 and 10-2025-0051308 filed on Apr. 21, 2025 in the Korean Intellectual Property Office, the disclosure of which is incorporated herein by reference in its entirety.

### TECHNICAL FIELD

The present disclosure relates to a multilayer electronic component.

### BACKGROUND

A multilayer ceramic capacitor (MLCC), a multilayer electronic component, is a chip-type capacitor mounted on the printed circuit boards of various types of electronic products, such as image display devices including liquid crystal displays (LCDs) and plasma display panels (PDPs), computers, smartphones, cell phones, and the like, to allow electricity to be charged therein and discharged therefrom.

Such an MLCC may be used as a component of various electronic devices due to advantages thereof, such as compactness, guaranteed high capacitance, and ease of mounting. As various electronic devices, such as computers and mobile devices, have been reduced in size and increased in power, demand for miniaturization and high capacitance of multilayer ceramic capacitors has increased.

In addition, as usage environments for MLCCs become increasingly harsh, a higher level of reliability is required.

### RELATED ART DOCUMENT

### Patent Document

(Patent Document 1) Korean Application Publication No. 10-2022-0057263

### SUMMARY

An aspect of the present disclosure is to provide a multilayer electronic component having improved reliability. Another aspect of the present disclosure is to provide a multilayer electronic component in which a capacitance reduction is suppressed.

Another aspect of the present disclosure is to provide a multilayer electronic component in which delamination or cracking at an interface between a cover portion and a capacitance formation portion is suppressed.

However, the objects of the present disclosure are not limited to the above-described contents and will be more easily understood when specific embodiments of the present disclosure are described.

According to an aspect of the present disclosure, a multilayer electronic component includes: a body including a capacitance formation portion including a dielectric layer and internal electrodes arranged alternately with the dielectric layer in a thickness direction and a cover portion disposed above and below the capacitance formation portion in the thickness direction; and an external electrode disposed on the body, wherein the cover portion includes an inner cover portion adjacent to the capacitance formation portion and an outer cover portion adjacent to an outer surface of the cover portion, and wherein, when an average value of a major axis length and a minor axis length of grains is a grain size, a grain having a grain size of 500 nm or less is a first grain, and a grain having a grain size of 1150 nm or more is a second grain, the inner cover portion includes a plurality of first grains, and the outer cover portion includes a plurality of first grains and a plurality of second grains.

According to another aspect of the present disclosure, a multilayer electronic component includes: a body including a capacitance formation portion including a dielectric layer and internal electrodes arranged alternately with the dielectric layer in a thickness direction and a cover portion disposed above and below the capacitance formation portion in the thickness direction; and an external electrode disposed on the body, wherein the cover portion includes an inner cover portion adjacent to the capacitance formation portion and an outer cover portion adjacent to an outer surface of the cover portion, and when an average value of a major axis length and a minor axis length of the grain is a grain size, the outer cover portion includes a region in which a standard deviation of the grain size is twice or more that of the inner cover portion.

### BRIEF DESCRIPTION OF DRAWINGS

The and other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment of the present disclosure;

FIG. 2 is a cross-sectional view taken along line I-I′ of FIG. 1;

FIG. 3 is a cross-sectional view taken along line II-II′ of FIG. 1;

FIG. 4 is an exploded view of a body of FIG. 1;

FIG. 5 is an enlarged view of region K of FIG. 3;

FIG. 6 is a schematic enlarged view of region K2 of FIG. 5;

FIG. 7 is a schematic enlarged view of region K5 of FIG. 5;

FIG. 8 is a diagram illustrating a grain size;

FIG. 9A is an image of a region corresponding to region K1 of FIG. 5, scanned by an SEM;

FIG. 9B is an image of a region corresponding to region K2 of FIG. 5, scanned by an SEM;

FIG. 10 is an image of a region corresponding to region K3 of FIG. 5, scanned by an SEM;

FIG. 11A is an image of a region corresponding to K4 in FIG. 5, scanned with a scanning electron microscope (SEM);

FIG. 11B is an image of a region corresponding to K5 in FIG. 5, scanned by an SEM;

FIG. 11C is an image of a region corresponding to K6 in FIG. 5, scanned by an SEM;

FIG. 11D is an image of a region corresponding to K7 in FIG. 5, scanned by an SEM;

FIG. 12 is an enlarged image of region K8 in FIG. 10;

FIG. 13 is a diagram corresponding to FIG. 3 according to a first embodiment of the present disclosure;

FIG. 14 is a perspective view schematically illustrating a multilayer electronic component according to a second embodiment of the present disclosure;

FIG. 15 is a schematic illustration excluding external electrodes in FIG. 14;

FIG. 16 is a schematic illustration excluding margin portions in FIG. 15; and

FIG. 17 is a cross-sectional view taken along line III-III′ of FIG. 14.

### DETAILED DESCRIPTION

Hereinafter, embodiments of the present inventive concept will be described in detail with reference to the accompanying drawings. The inventive concept may, however, be exemplified in many different forms and should not be construed as being limited to the specific embodiments set forth herein. Rather, these embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

In the drawings, the X-direction may be defined as a first direction, stacking direction, or thickness (T) direction, the Y-direction may be defined as a second direction or length (L) direction, and the Z-direction may be defined as a third direction or width (W) direction.

### Multilayer Electronic Component

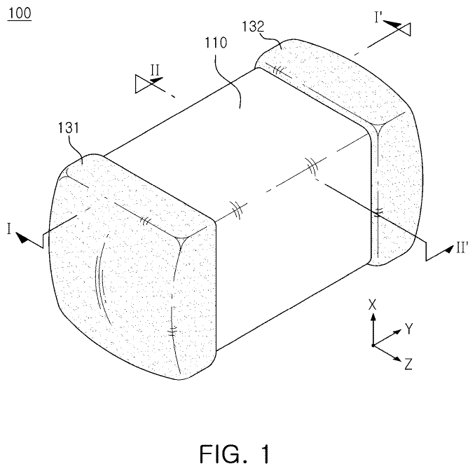

FIG. 1 is a perspective view schematically illustrating a multilayer electronic component according to an embodiment of the present disclosure.

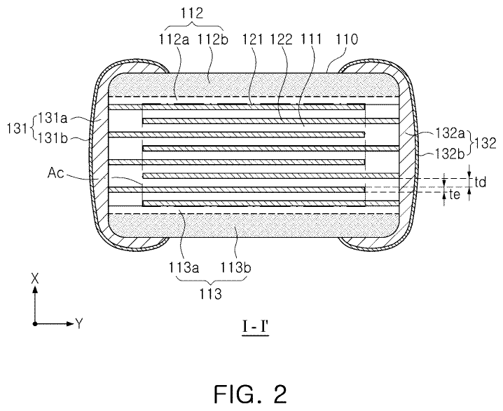

FIG. 2 is a cross-sectional view taken along line I-I′ of FIG. 1.

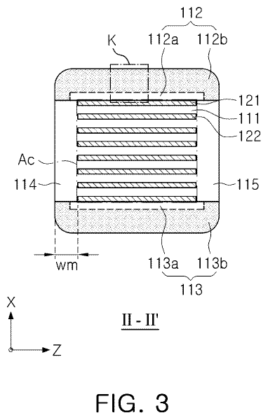

FIG. 3 is a cross-sectional view taken along line II-II′ of FIG. 1.

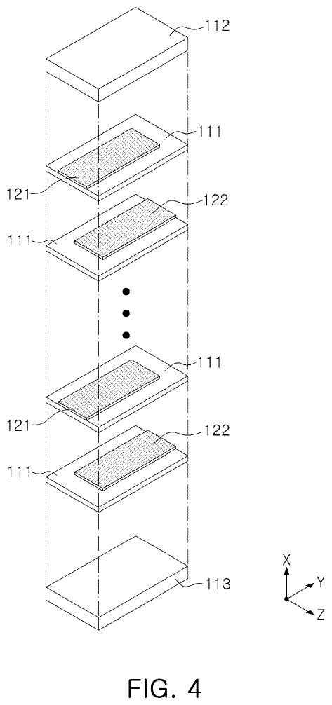

FIG. 4 is an exploded view of a body of FIG. 1.

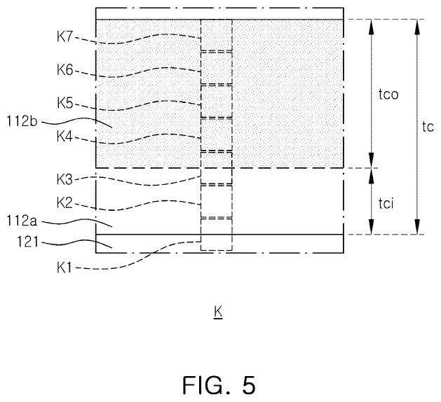

FIG. 5 is an enlarged view of region K of FIG. 3.

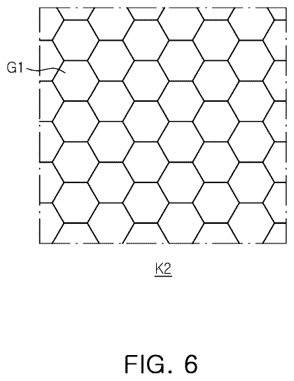

FIG. 6 is a schematic enlarged view of region K2 of FIG. 5.

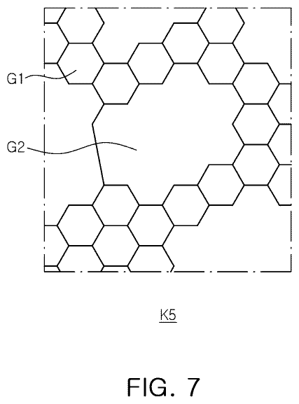

FIG. 7 is a schematic enlarged view of region K5 of FIG. 5.

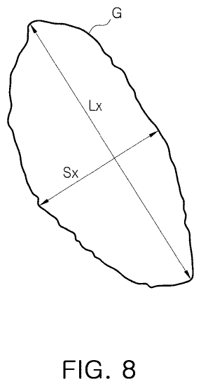

FIG. 8 is a diagram illustrating a grain size.

Hereinafter, a multilayer electronic component 100 according to an embodiment of the present disclosure will be described in detail with reference to FIGS. 1 through 8. Furthermore, while a multilayer ceramic capacitor (MLCC) is described as an example of a multilayer electronic component, the present disclosure is not limited thereto and may be applied to various multilayer electronic components using ceramic materials, such as inductors, piezoelectric devices, varistors, or thermistors.

A length of the multilayer electronic component 100 may be greater than a width and thickness of the multilayer electronic component 100; however, the present disclosure is not limited thereto. For example, the length of the multilayer electronic component 100 may be less than the width of the multilayer electronic component 100. The width of the multilayer electronic component 100 may be smaller or greater than the thickness of the multilayer electronic component 100, and this may vary depending on target specifications and characteristics of the multilayer electronic component 100.

The length of the multilayer electronic component 100 may be, for example, about 0.1 mm to about 5.7 mm, the width of the multilayer electronic component 100 may be, for example, about 0.05 mm to about 5.0 mm, and the thickness of the multilayer electronic component 100 may be, for example, about 0.05 mm to about 5.0 mm.

The multilayer electronic component 100 according to an embodiment of the present disclosure may include a body 110 and external electrodes 131 and 132.

The body 110 may include a dielectric layer 111 and internal electrodes 121 and 122 arranged alternately with the dielectric layer in the thickness direction.

While there are no specific limitations on the specific shape of the body 110, as illustrated, the body 110 may be formed to have a hexahedral shape or a similar shape. Due to shrinkage of ceramic powder particles included in the body 110 during a sintering process, the body 110 may not be a perfectly straight hexahedral shape, but may have a substantially hexahedral shape.

The body 110 may have first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth surfaces 1, 2, 3, and 4 and opposing each other in the width direction.

As margin portions in which the internal electrodes 121 and 122 are not arranged overlap on the dielectric layer 111, a step difference may be created due to the thickness of the internal electrodes 121 and 122, and thus, the corners connecting the first surface and the third to fifth surfaces and/or the corners connecting the second surface and the third to fifth surfaces may have a shape contracted toward the center of the body 110 in the first direction when viewed based on the first or second surface. Alternatively, due to shrinkage behavior during the sintering process of the body, the corners connecting the first surface 1 to the third to sixth surfaces 3, 4, 5, and 6 and/or the corners connecting the second surface 2 to the third to sixth surfaces 3, 4, 5, and 6 may have a shape contracted toward the center of the body 110 in the first direction when viewed based on the first surface or the second surface. Alternatively, in order to prevent chipping defects, etc., a separate process may be performed to round the corners connecting each surface of the body 110, so that the corners connecting the first surface to the third to sixth surfaces and/or the corners connecting the second surface to the third to sixth surfaces may have a round shape.

To suppress a step difference caused by the internal electrodes 121 and 122, after stacking, the internal electrodes may be cut to be exposed to the fifth and sixth surfaces 5 and 6 of the body and a single dielectric layer or two or more dielectric layers may be stacked on both sides of a capacitance formation portion Ac in the third direction (the width direction) to form the side margin portions 114 and 115. In this case, the portions connecting the first surface to the fifth and sixth surfaces and the portions connecting the second surface to the fifth and sixth surfaces may not have a contracted shape.

The plurality of dielectric layers 111 comprising the body 110 are in a sintered state, and adjacent dielectric layers 111 may be integrated such that boundaries therebetween may not be readily apparent without using a scanning electron microscope (SEM). The number of stacked dielectric layers is not particularly limited and may be determined based on the size of the multilayer electronic component. For example, the body may be formed by stacking 400 or more dielectric layers.

The dielectric layer 111 may be formed by preparing a ceramic slurry including ceramic powder, an organic solvent, and a binder, applying the slurry onto a carrier film and drying the slurry to form a ceramic green sheet, and then sintering the ceramic green sheet. The ceramic powder is not particularly limited as long as it may achieve sufficient capacitance. For example, barium titanate (BaTiO₃)-based powder may be used. For more specific examples, the ceramic powder may be barium titanate (BaTiO₃) powder, CaZrO₃-based paraelectric powder, etc. For more specific examples, the barium titanate (BaTiO₃)-based powder may be one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1), and the CaZrO₃-based paraelectric powder may be (Ca₁₋ₓSrₓ)(Zr_{1-y}Ti_{y})O₃ (0<x<1, 0<y<1).

In an embodiment, the dielectric layer 111 may include, as a main component, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), Ba(Ti_{1-y}Zr_{y})O₃ (0<y<1), and (Ca₁₋ₓSrₓ) (Zr_{1-y}Ti_{y})O₃ (0<x<1, 0<y<1).

The body 110 may include the capacitance formation portion Ac including the dielectric layer 111 and the internal electrodes 121 and 122 alternately arranged with the dielectric layer in the thickness direction and the cover portions 112 and 113 arranged above and below the capacitance formation portion in the thickness direction.

The cover portions 112 and 113 may include an upper cover portion 112 disposed above the capacitance formation portion Ac in the thickness direction and a lower cover portion 112 disposed below the capacitance formation portion Ac in the thickness direction.

Furthermore, the capacitance formation portion Ac contributes to the capacitance formation of the capacitor and may be formed by repeatedly stacking a plurality of first and second internal electrodes 121 and 122 with the dielectric layer 111 interposed therebetween. The stacking direction of the internal electrodes 121 and 122 may be the thickness direction or the width direction. In this disclosure, an embodiment in which the stacking direction of the internal electrodes 121 and 122 is the thickness direction will be described.

The cover portions 112 and 113 may include inner cover portions 112a and 113a adjacent to the capacitance formation portion Ac and outer cover portions 112b and 113b adjacent to outer surfaces of the cover portions 112 and 113.

In an embodiment, when an average value of a major axis length Lx and a minor axis length Sx of a grain G is defined as a grain size, a grain having a grain size of 500 nm or less is defined as a first grain G1, and a grain having a grain size of 1150 nm or greater is defined as a second grain G2, the inner cover portions 112a and 113a may include a plurality of first grains G1, and the outer cover portions 112b and 113b may include a plurality of first grains G1 and a plurality of second grains G2.

Referring to FIG. 6, which is an enlarged view of a portion of a cross-section of the inner cover portions 112a and 113a, the inner cover portions 112a and 113a include a plurality of first grains G1, thereby enhancing bonding strength with the capacitance formation portion Ac and suppressing a capacitance reduction in the multilayer electronic component. Furthermore, the interfacial bonding between the capacitance formation portion Ac and the cover portions 112 and 113 may be enhanced, thereby suppressing delamination and interface cracking.

Referring to FIG. 7, which is an enlarged view of a portion of the cross-section of the outer cover portions 112b and 113b, the outer cover portions 112b and 113b include a mixture of a plurality of first grains G1 and a plurality of second grains G2, and thus, moisture infiltration from the outside may be blocked, thereby improving moisture resistance reliability. Furthermore, a crack propagation path may be increased when cracking occurs, thereby improving bonding strength.

Referring to FIG. 8, in the present disclosure, the grain size may refer to an average value of the major axis length Lx and minor axis length Sx of the grain G. The major axis length Lx of a grain may refer to the length of the longest straight line connecting two points forming an outer perimeter of the grain G, while the minor axis length Sx of a grain may refer to the length of the longest straight line connecting two points forming the outer perimeter of the grain G and perpendicular to the major axis of the grain. The average value may refer to an arithmetic mean.

The first grain G1 has a general grain size of 500 nm or less, while the second grain G2 has a larger grain size of 1150 nm or greater. The second grain G2 may be formed by abnormal grain growth. Abnormal grain growth refers to a phenomenon in which some grains grow abnormally larger than the surrounding grains during a sintering process. The inner cover portions 112a and 113a include the first grains G1 having a normal grain size due to normal grain growth, while the outer cover portions 112b and 113b include a mixture of a plurality of first grains G1 and a plurality of second grains G2, as some grains grow abnormally larger than the surrounding grains due to abnormal grain growth.

The formation of second grains G2 due to abnormal grain growth generally has negative side effects, such as reduced permittivity, reduced insulation resistance, and reduced reliability, and thus, the formation of second grains G2 has been generally suppressed. However, these negative effects mostly occur when abnormal grain growth occurs in the dielectric layer within the capacitance formation portion Ac or in a region of the cover portions adjacent to the capacitance formation portion Ac. In the case of the outer cover portions 112b and 113b, even if the second grains G2 are formed, there are no negative effects, such as reduced permittivity, reduced insulation resistance, or reduced reliability. Rather, the presence of a mixture of a plurality of first grains G1 and a plurality of second grains G2 within the outer cover portions 112b and 113b may block moisture from penetrating from the outside, thereby improving moisture resistance reliability.

Furthermore, the inner cover portions 112a and 113a include a plurality of first grains G1, thereby enhancing bonding strength with the capacitance formation portion Ac and suppressing a capacitance reduction of the multilayer electronic component.

In an embodiment, the inner cover portions 112a and 113a may have an average grain size of 300 nm or less. Accordingly, bonding strength with the capacitance formation portion Ac may be further enhanced and a capacitance reduction of the multilayer electronic component may be further suppressed.

Here, the average grain size may be an arithmetic mean of the grain sizes of 100 or more grains.

The average value of the sizes of the grains included in the outer cover portions 112b and 113b may be greater than the average value of the sizes of the grains included in the inner cover portions 112a and 113a. For example, the average value of the sizes of the grains included in the outer cover portions 112b and 113b may be 350 nm or greater. However, since the outer cover portions 112b and 113b include a plurality of first grains G1 as well as the second grains G2, the average value of the sizes of the grains included in the outer cover portions 112b and 113b may not differ significantly from the average value of the sizes of the grains included in the inner cover portions 112a and 113a. For example, the average value of the sizes of the grains included in the outer cover portion 112b and 113b may be less than or equal to twice the average value of sizes of the grains included in the inner cover portions 112a and 113a.

In an embodiment, the outer cover portions 112b and 113b may include a region in which the standard deviation of the grain size is twice or more that of the inner cover portions. Since the inner cover portions 112a and 113a have a uniform grain size, bonding strength with the capacitance formation portion Ac may be improved and a capacitance reduction of the multilayer electronic component may be suppressed. Since the outer cover portions 112b and 113b have non-uniform grain sizes, the outer cover portions 112b and 113b may block moisture penetrating from the outside, thereby improving moisture resistance reliability. In this case, the outer cover portions 112b and 113b may include grains having a grain size of 1150 nm or greater.

In an embodiment, the standard deviation of the grain size in the region within 20 μm of the capacitance formation portion Ac of the cover portions 112 and 113 may be twice or more that of the region within 20 μm of the outer surface of the cover portions 112 and 113.

As described herein, the average value of the sizes of grains included in the outer cover portions 112b and 113b may not be significantly different from the average value of the sizes of the grains included in the inner cover portions 112a and 113a. However, since the outer cover portions 112b and 113b include a plurality of first grains G1 and a plurality of second grains G2, the standard deviations of the grain sizes may differ significantly.

In an embodiment, the standard deviation of the grain size of the inner cover portions 112a and 113a may be 130 nm or less. Accordingly, the inner cover portions 112a and 113a have uniform grain sizes, thereby further enhancing bonding strength with the capacitance e formation portion Ac and suppressing a capacitance reduction in the multilayer electronic component.

In an embodiment, the outer cover portions 112b and 113b may have a standard deviation of grain sizes of 260 nm or greater. Consequently, the outer cover portions 112b and 113b have non-uniform grain sizes, which may form longer and more complex moisture penetration paths and/or crack propagation paths, thereby further improving moisture resistance reliability and bonding strength.

Here, the standard deviation of grain sizes may be a value obtained using any known method such as, for example, by using STDEV. P function (sample standard deviation) in the Microsoft Excel™ application, from the grain sizes of 100 or more grains.

Not all grains included in the inner cover portions 112a and 113a need to be first grains of 500 nm or less in size, and some larger grains may be included. However, the maximum size of the grains included in the inner cover portions 112a and 113a may preferably be 1, 100 nm or less.

When the second grains G2 are formed in the inner cover portions 112a and 113a due to abnormal grain growth, abnormal grain growth may also occur in the dielectric layer 111 of the capacitance formation portion Ac, potentially reducing the capacitance or weakening the bonding strength with the dielectric layer 111 of the capacitance formation portion Ac.

In an embodiment, the maximum size of the grains included in the outer cover portions 112b and 113b may be 2, 300 nm or greater. The outer cover portions 112b and 113b may have large grains of 2, 300 nm or greater due to abnormal grain growth, and even larger grains of 4,000 nm or greater may also be observed.

In an embodiment, in a cross-section of the outer cover portions 112b and 113b in the thickness and width directions, the ratio of the area occupied by the plurality of second grains G2 to the area of the outer cover portions 112b and 113b may be 50% or more and 95% or less. Even if the number of first grains G1 is greater than that of the second grains G2, the ratio of the area occupied by the plurality of second grains G2 may be 50% or more due to the larger grain size of the second grains, thereby further improving moisture resistance reliability. However, if the ratio of the area occupied by the plurality of second grains G2 exceeds 95%, the non-uniformity of the grain sizes of the outer cover portions 112b and 113b may rather decrease and cracks may occur due to external stress.

In an embodiment, the ratio of the area occupied by the first grains G1 to the area of the inner cover portions 112a and 113a in cross-section of the inner cover portions 112a and 113a in the thickness and width directions may be 90% or greater.

Not all grains included in the inner cover portions 112a and 113a need to be the first grains of 500 nm or less, and some large grains may be included. However, when the ratio of the area occupied by the first grain G1 to the area of the inner cover portions 112a and 113a is 90% or greater, the bonding strength between the inner cover portions 112a and 113a and the capacitance formation portion Ac may be further enhanced and a capacitance reduction of the multilayer electronic component may be further suppressed.

In an embodiment, a ratio (tco/tc) of the average thickness tc of the outer cover portion 112b and 113b to the average thickness tco of the inner cover portions 112a and 113a may be 50% or more and 80% or less. Accordingly, the effect of improving the bonding strength between the cover portions 112 and 113 and the capacitance formation portion Ac, the effect of suppressing a capacitance reduction, the effect of improving moisture resistance reliability, the effect of improving bending strength, etc. according to the present disclosure may be further improved.

The average thickness tc of the cover portions 112 and 113 may be, for example, 150 μm or less, 100 μm or less, 30 μm or less, or 20 μm or less. The average thickness tc of the cover portions 112 and 113 may be, for example, 5 μm or more or 10 μm or more. The average thickness tc of the cover portions 112 and 113 refers to an average thickness of each of the upper cover portion 112 and the lower cover portion 113.

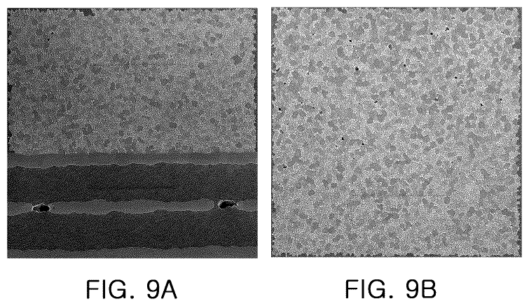

FIG. 9A is an image of a region corresponding to region K1 of FIG. 5, scanned by an SEM, and FIG. 9B is an image of a region corresponding to region K2 of FIG. 5, scanned by an SEM.

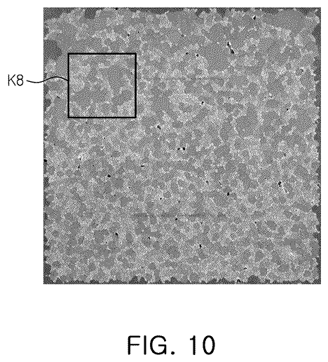

FIG. 10 is an image of a region corresponding to region K3 of FIG. 5, scanned by an SEM.

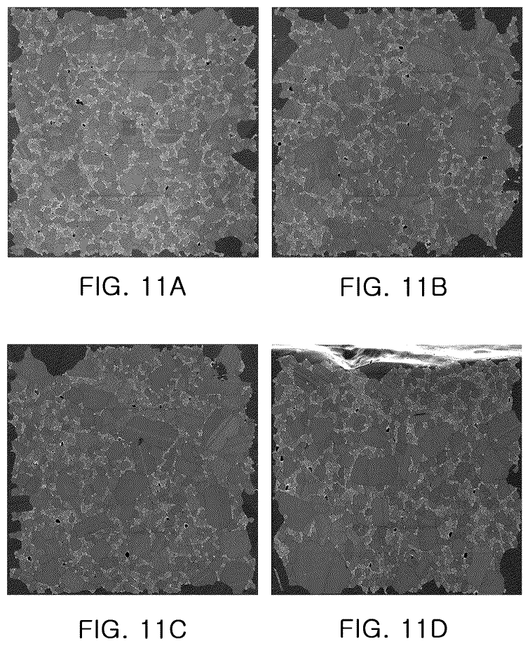

FIG. 11A is an image of a region corresponding to K4 in FIG. 5, scanned by an SEM, FIG. 11B is an image of a region corresponding to K5 in FIG. 5, scanned by an SEM, FIG. 11C is an image of a region corresponding to K6 in FIG. 5, scanned by an SEM, and FIG. 11D is an image of a region corresponding to K7 in FIG. 5, scanned by an SEM.

Table 1 below also lists an average grain size (Avg), a standard deviation (Stdev), and maximum grain size (Max) for the regions K1 to K7.

TABLE 1

| | Inner cover | | | | | | |
|---|---|---|---|---|---|---|---|
| | portion | | | Outer cover portion | | | |
| Classification | K1 | K2 | K3 | K4 | K5 | K6 | K7 |
| Avg (nm) | 269 | 287 | 349 | 404 | 440 | 462 | 324 |
| Stdev (nm) | 122 | 125 | 175 | 268 | 326 | 379 | 304 |
| Max (nm) | 888 | 1077 | 2370 | 3078 | 3741 | 4235 | 4813 |

Hereinafter, a method of obtaining the images of FIGS. 9 to 12 will be described. First, the multilayer electronic component 100 may be polished to the center in the length direction to expose the cross-section in the thickness and width directions. Thereafter, images may be obtained by scanning regions corresponding to K1 to K7 from the capacitance formation portion to the outer portion in the region corresponding to FIG. 5 using a scanning electron microscope. The images of FIGS. 9 to 11 are images obtained by scanning a region of 22 μm×22 μm, respectively. Thereafter, the grain size may be obtained by using an image analysis program, such as ImageJ for each image. The grains indicated in color in the images of FIGS. 9 to 11 are grains whose grain size was measured, and grains closer to yellow color may be small in grain size, and grains closer to red color may be large in grain size. Using the image analysis program, not only may the average values of the major axis length Lx and minor axis length Sx of each grain be obtained, thereby obtaining data on grain size, but also, as illustrated in FIGS. 9 to 11, grain sizes may be distinguished by color, facilitating grain size analysis. Grains that were scanned only partially were excluded, and grains in the capacitance formation portion in FIG. 9A, which is the K1 region, were excluded. Grains excluded from grain size analysis in this manner were not given separate colors in FIGS. 9A to 11D.

Furthermore, grains scanned with only a portion thereof were excluded, and in FIG. 9A, the grains in the capacitance formation portion were excluded. These grains excluded from grain size analysis were not assigned a separate color in FIGS. 9 to 11.

Referring to FIGS. 9A and 9B, it can be seen that the grain sizes in K1 and K2, the inner cover portions 112a and 113a adjacent to the capacitance formation portion, are uniform and no large grains are observed. Also, referring to Table 1, it can be seen that, K1 and K2 include uniform grains, with an average grain size (Avg) of 300 nm or less and a standard deviation (Stdev) of 130 nm or less. In addition, K1 and K2 mostly include primary grains, but some grains have a maximum grain size of 1,077 nm, indicating the presence of some large grains. However, second grains having a size 1, 150 nm or greater were not observed.

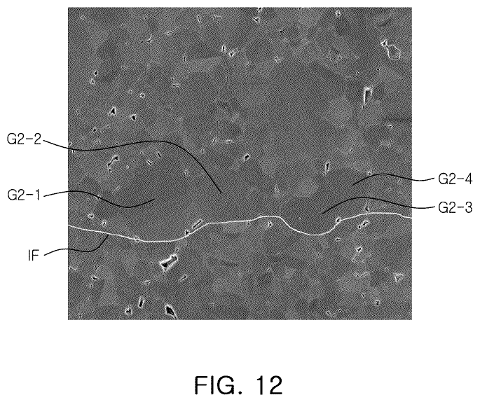

FIG. 10 corresponds to region K3, in which both the inner cover portions 112a and 113a and the outer cover portions 112b and 113b are observed, and large second grains start to be observed. Referring to FIG. 12, which is an enlarged image of the K8 region of FIG. 10, the boundary IF of the inner cover portions 112a and 113a and the outer cover portions 112b and 113b may be determined by connecting the second grains G2-1, G2-2, G2-3, and G2-4 adjacent to the inner cover portion along the shortest path along the grain boundary.

Based on the boundary IF determined in this manner, a value obtained by averaging the thicknesses of the outer cover portions 112b and 113b measured at 10 equally spaced points in the width direction may be used as the average thickness tco of the outer cover portions, a value obtained by averaging thicknesses of the inner cover portions 112a and 113a may be used as the average thickness tci of the inner cover portions, and a value obtained by averaging the thicknesses of the cover portions 112 and 113 may be used as the average thickness tc of the cover portions 112 and 113. Here, tco, tci, and tc may be measured at either the upper cover portion 112 or the lower cover portion 113. However, without being limited thereto, tco, tci, and tc may also be values obtained by averaging the values measured at the upper cover portion 112 and the lower cover portion 113.

Referring to FIGS. 11A to 11D, it can be seen that a plurality of first grains G1 with a grain size of 500 nm or less and a plurality of second grains G2 with a grain size of 1150 nm or greater are observed in the outer cover portions 112b and 113b, which are K4 to K7. Except for the final region, K7, the average grain size (Avg), standard deviation (Stdev), and maximum grain size (Max) tend to increase toward the outer surface of the cover portion.

Grains with a maximum grain size (Max) of 3,000 nm or greater were observed in K4 and K5, while grains with a maximum grain size (Max) of 4,000 nm or greater were observed in K6 and K7, clearly indicating the occurrence of abnormal grain growth.

The method of manufacturing the cover portions 112 and 113 according to the present disclosure may not be particularly limited. The cover portions 112 and 113 according to the present disclosure may be manufactured by controlling the sintering temperature, sintering time, additives, etc., which are the main causes of abnormal grain growth.

For example, by adding Dy as an additive to the cover portions 112 and 113 and appropriately controlling the sintering temperature and time, abnormal grain growth may be induced only in the outer cover portions 112b and 113b.

In an embodiment, in the cover portions 112 and 113, the number of moles of Dy based on 100 moles of Ti may be 3.7 to 4.5. Dy is generally known to inhibit grain growth when added to a dielectric composition. However, according to an embodiment of the present disclosure, when a large amount of Dy is added to the cover portions 112 and 113 such that the number of moles of Dy based on 100 moles of Ti is 3.7 to 4.5, abnormal grain growth may be induced in the outer cover portions 112b and 113b, while uniform grain growth may be induced in the inner cover portions 112a and 113a.

For a specific example, the cover portions 112 and 113 may be formed by preparing a ceramic slurry including ceramic powder, an organic solvent, a binder, and an additive including Dy, applying the slurry onto a carrier film, drying the same to form a ceramic green sheet, and then sintering the ceramic green sheet. The ceramic is not particularly limited as long as it may achieve sufficient capacitance. For example, barium titanate (BaTiO₃) powder may be used. For a more specific example, the ceramic powder may be a barium titanate (BaTiO₃)-based powder, a CaZrO₃-based paraelectric powder, etc. For a more specific example, the barium titanate (BaTiO₃)-based powder may be one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1), and the CaZrO₃-based paraelectric powder may be (Ca₁₋ₓSrₓ) (Zr_{1-y}Ti_{y})O₃ (0<x<1, 0<y<1). Dy may be added in the form of Dy₂O₃ and may be added so that the number of moles of Dy based on 100 moles of Ti is 3.7 to 4.5.

Therefore, the cover portions 112 and 113 may include, as a primary component, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), Ba(Ti_{1-y}Zr_{y})O₃ (0<y<1) and (Ca₁₋ₓSrₓ) (Zr_{1-y}Ti_{y})O₃ (0<x<1, 0<y<1) and may include, as a secondary component, 3.7 to 4.5 moles of Dy based on 100 moles of Ti.

In addition, the cover portions 112 and 113 may include Dy, Mg, Mn, and Si as additives. The number of moles of Dy may be 3.7 to 4.5, the number of moles of Mg may be 0.18 to 0.22, the number of moles of Mn may be 0.225 to 0.275, and the number of moles of Si may be 1.17 to 1.43, based on 100 moles of Ti.

In addition, the cover portions 112 and 113 may further include Ba as an additive, and the number of moles of Ba, added as an additive, based on 100 moles of Ti, may be 0.63 to 0.77.

In addition, as an example of a more specific method for measuring the content of an element included in a configuration of the multilayer electronic component 100 in the present disclosure, the components may be analyzed using the Energy Dispersive X-ray Spectroscopy (EDS) mode of a scanning electron microscope (SEM), an EDS mode of a transmission electron microscope (TEM), or an EDS mode of a scanning transmission electron microscope (STEM). First, a thinned analysis sample is prepared using a focused ion beam (FIB) device in a region to be measured. Then, a damage layer on a surface of the thinned sample is removed using xenon (Xe) or argon (Ar) ion milling, and then each component to be measured is mapped from the image obtained using the SEM-EDS, TEM-EDS, or STEM-EDS to perform a qualitative/quantitative analysis. In this case, the qualitative/quantitative analysis of each component may be expressed in terms of the content of each element, for example, weight percentage (wt %), atomic percentage (at %), or molar percentage (mol %), and it may also be expressed by converting the content of a specific component into the content of another specific component.

Alternatively, a chip may be crushed to select a region to be measured, and a specific component of a corresponding region of a portion including a selected dielectric microstructure may be analyzed using a device, such as an inductively coupled plasma optical spectroscopy (ICP-OES) or an inductively coupled plasma mass spectrometer (ICP-MS).

In an embodiment, the dielectric layer 111 may include a plurality of first grains G1, and an average grain size may be 300 nm or less. Since the dielectric layer 111 has a similar grain structure to that of the inner cover portions 112a and 113a, interfacial bonding between the capacitance formation portion Ac and the cover portions 112 and 113 may be enhanced, thereby suppressing delamination and interfacial cracking.

In an embodiment, in the dielectric layer 111, the number of moles of Dy based on 100 moles of Ti may be 3.7 to 4.5. Since the dielectric layer 111 has a composition similar to the inner cover portions 112a and 113a, the interfacial bonding between the capacitance formation portion Ac and the cover portions 112 and 113 may be further enhanced, thereby further enhancing the effect of suppressing delamination and interfacial cracking. Furthermore, the dielectric layer may be formed using a ceramic green sheet for forming the cover portions 112 and 113, thereby simplifying the process.

Here, in the dielectric layer 111, based on 100 mols of Ti, the number of moles of Dy may be 3.7 to 4.5, the number of moles of Mg may be 0.18 to 0.22, the number of moles of Mn may be 0.225 to 0.275, and the number of moles of Si may be 1.17 to 1.43. Also, the dielectric layer 111 may further include Ba as an additive, and the number of moles of Ba added as an additive, based on 100 mols of Ti, may be 0.63 to 0.77.

The margin portions 114 and 115 may be arranged on the side surfaces of the capacitance formation portion Ac.

The margin portions 114 and 115 may include a first margin portion 114 disposed on the fifth surface 5 of the body 110 and a second margin portion 115 disposed on the sixth surface 6. That is, the margin portions 114 and 115 may be disposed on both end surfaces of the ceramic body 110 in the width direction.

The margin portions 114 and 115 may refer to a region between both ends of the first and second internal electrodes 121 and 122 and the boundary of the body 110 in a cross-section of the body 110 taken in the width-thickness (W-T) direction.

The margin portions 114 and 115 may fundamentally serve to prevent damage to the internal electrodes due to physical or chemical stress.

The margin portions 114 and 115 may be formed by applying conductive paste to the ceramic green sheet, excluding the region in which the margins will be formed, to form the internal electrodes.

In addition, to suppress a step difference caused by the internal electrodes 121 and 122, after stacking, the internal electrodes may be cut to be exposed to the fifth and sixth surfaces 5 and 6 of the body, and then, a single dielectric layer or two or more dielectric layers may be stacked on both sides of the capacitance formation portion Ac in the third direction (width direction) to form the margin portions 114 and 115.

A width wm of the margin portions 114 and 115 may not be particularly limited. An average width of the margin portions 114 and 115 may be, for example, 150 μm or less, 100 μm or less, 20 μm or less, or 15 μm or less. The average width of the margin portions 114 and 115 may be, for example, 5 μm or more or 10 μm or more. The average width of the margin portions 114 and 115 refers to the average width of each of the first margin portion 114 and the second margin portion 115. The average width of the margin portions 114 and 115 may be a value obtained by averaging widths measured at five equally spaced points in the thickness direction in the cross-section of the multilayer electronic component 100 in the width and thickness directions.

The internal electrodes 121 and 122 may include first and second internal electrodes 121 and 122. The first and second internal electrodes 121 and 122 are alternately arranged to face each other with the dielectric layer 111 forming the body 110 interposed therebetween, and may be exposed to the third and fourth surfaces 3 and 4 of the body 110, respectively.

The internal electrodes 121 and 122 may include first and second internal electrodes 121 and 122. The first and second internal electrodes 121 and 122 are alternately arranged to face each other with the dielectric layer 111 forming the body 110 interposed therebetween and may be exposed through the third and fourth surfaces 3 and 4 of the body 110, respectively.

The first internal electrode 121 may be spaced apart from the fourth surface 4 and exposed through the third surface 3, while the second internal electrode 122 may be spaced apart from the third surface 3 and exposed through the fourth surface 4. The first external electrode 131 may be disposed on the third surface 3 of the body and connected to the first internal electrode 121, and the second external electrode 132 may be disposed on the fourth surface 4 of the body and connected to the second internal electrode 122.

That is, the first internal electrode 121 may be connected to the first external electrode 131 and not to the second external electrode 132, and the second internal electrode 122 may be connected to the second external electrode 132 and not to the first external electrode 131. Therefore, the first internal electrode 121 may be formed at a predetermined distance from the fourth surface 4, and the second internal electrode 122 may be formed at a predetermined distance from the third surface 3. In addition, the first and second internal electrodes 121 and 122 may be spaced apart from the fifth and sixth surfaces of the body 110.

A conductive metal included in the internal electrodes 121 and 122 may be one or more of Ni, Cu, Pd, Ag, Au, Pt, In, Sn, Al, W, Ti, and alloys thereof, but the present disclosure is not limited thereto.

An average thickness td of the dielectric layer 111 may not be particularly limited, but may be, for example, 0.1 μm to 10 μm. An average thickness the of the internal electrodes 121 and 122 may not be particularly limited, but may be, for example, 0.05 μm to 3.0 μm. In addition, the average thickness td of the dielectric layer 111 and the average thickness the of the internal electrodes 121 and 122 may be arbitrarily set according to the desired characteristics or purpose. For example, to achieve miniaturization and high capacitance, in the case of electronic components for high-voltage electric devices, the average thickness td of the dielectric layer 111 may be less than 2.8 μm, and the average thickness the of the internal electrodes 121 and 122 may be less than 1 μm. In addition, to achieve miniaturization and high capacitance, in the case of small IT electronic components, the average thickness td of the dielectric layer 111 may be 0.4 μm or less, and the average thickness the of the internal electrodes 121 and 122 may be 0.4 μm or less.

An average thickness td of the dielectric layer 111 and the average thickness the of the internal electrodes 121 and 122 refer to the sizes of the dielectric layer 111 and the internal electrodes 121 and 122, respectively, in the first direction. The average thickness td of the dielectric layer 111 and the average thickness the of the internal electrodes 121 and 122 may be measured by scanning a cross-section of the body 110 in the first and second directions using a scanning electron microscope (SEM) at 10,000× magnification. More specifically, the average thickness td of the dielectric layer 111 may be obtained by measuring the thicknesses at a plurality of points on one dielectric layer 111, for example, 30 equally spaced points in the second direction, and then calculating an average value. Furthermore, the average thickness the of the internal electrodes 121 and 122 may be obtained by measuring the thicknesses at a plurality of points on one internal electrode 121 or 122, for example, 30 equally spaced points in the second direction, and then calculating an average value. The 30 equally spaced points may be designated in the capacitance formation portion Ac. By performing the average value measurement on ten dielectric layers 111 and ten internal electrodes 121 and 122 and then calculating the average value, the average thickness td of the dielectric layer 111 and the average thickness the of the internal electrodes 121 and 122 may be further generalized.

The external electrodes 131 and 132 may be disposed on the third surface 3 and the fourth surface 4 of the body 110.

The external electrodes 131 and 132 may be disposed on the third and fourth surfaces 3 and 4 of the body 110, respectively, and may include first and second external electrodes 131 and 132 connected to the first and second internal electrodes 121 and 122, respectively.

Referring to FIG. 1, the external electrodes 131 and 132 may be arranged to cover both end surfaces of the margin portions 114 and 115 in the second direction.

In the present embodiment, a structure in which the multilayer electronic component 100 has two external electrodes 131 and 132 is described. However, the number and shape of the external electrodes 131 and 132 may vary depending on the shape of the internal electrodes 121 and 122 or other purposes.

The external electrodes 131 and 132 may be formed using any material having electrical conductivity, such as metal. A specific material may be determined based on electrical characteristics, structural stability, and other factors. Furthermore, the external electrodes may have a multilayer structure.

For example, the external electrodes 131 and 132 may include electrode layers 131a and 132a disposed on the body 110 and plating layers 131b and 132b formed on the electrode layers 131a and 132a.

More specifically, the electrode layers 131a and 132a may be sintered electrodes including a conductive metal and glass or resin-based electrodes including a conductive metal and resin.

Furthermore, the electrode layers 131a and 132a may be formed by sequentially forming sintered electrodes and resin-based electrodes on the body. Furthermore, the electrode layers 131a and 132a may be formed by transferring a sheet including a conductive metal onto the body or by transferring a sheet including a conductive metal onto a sintered electrode.

The conductive metal included in the electrode layers 131a and 132a may be any material with excellent electrical conductivity and is not particularly limited. For example, the conductive metal may be one or more of nickel (Ni), copper (Cu), and alloys thereof.

The plating layers 131b and 132b serve to improve mounting characteristics. The type of plating layers 131b and 132b is not particularly limited and may include one or more of nickel, tin, palladium, and alloys thereof, and may be formed as a plurality of layers.

For a more specific example of the plating layers 131b and 132b, the plating layers 131b and 132b may be Ni or Sn plating layers. An Ni plating layer and an Sn plating layer may be sequentially formed on the electrode layers 131a and 132a, or an Sn plating layer, an Ni plating layer, and an Sn plating layer may be sequentially formed. In addition, the plating layers 131b and 132b may include a plurality of Ni plating layers and/or a plurality of Sn plating layers.

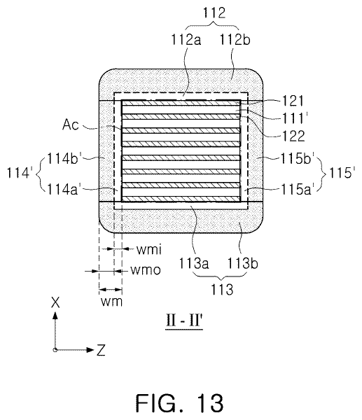

FIG. 13 is a diagram corresponding to FIG. 3 according to a first embodiment of the present disclosure

Referring to FIG. 13, margin portions 114′ and 115′ disposed on both widthwise surfaces of the capacitance formation portion Ac are included. The margin portions 114′ and 115′ may include inner margin portions 114a′ and 115a′ adjacent to the capacitance formation portion and outer margin portions 114b′ and 115b′ adjacent to outer surfaces of the margin portions.

In an embodiment, the inner margin portions 114a′ and 115a′ may include a plurality of first grains G1, and the outer margin portions 114b′ and 115b′ may each include a plurality of first grains G1 and second grains G2. Accordingly, the moisture resistance reliability of the multilayer electronic component may be further improved.

In an embodiment, an average value of grain sizes in the inner margin portions 114a′ and 115a′ may be 300 nm or less.

In an embodiment, the ratio of the average width wmo of the outer margin portions 114b′ and 115b′ to the average width wm of the margin portions 114′ and 115′ may be 50% or more and 80% or less. Accordingly, the effect of improving the bonding strength between the margin portions 114′ and 115′ and the capacitance formation portion Ac, the effect of suppressing capacitance reduction, the effect of improving moisture resistance reliability, and the effect of improving bending strength may be further improved.

The average value of the widths of the outer margin portions 114b′ and 115b′ measured at ten equally spaced points in the thickness direction may be set as the average width wmo of the outer margin portions 114b′ and 115b′, the average value of the widths of the inner margin portions 114a′ and 115a′ may be set as the average width wmi of the inner margin portions 114a′ and 115a′, and the average value of the widths of the margin portions 114′ and 115′ may be set as the average width wm of the margin portions 114′ and 115′. Here, wmo, wmi, and wm may be measured from either one of the first margin portion 114′ and the second margin portion 115′. However, without being limited thereto, wmo, wmi, and wm may be an average of the values measured at the first margin portion 114′ and the second margin portion 115′.

The margin portions 114′ and 115′ may be formed by applying a conductive paste to a ceramic green sheet having the same composition as the ceramic green sheet used to form the cover portions 112 and 113, excluding a region in which the margin portions are to be formed, to form internal electrodes. In this case, the dielectric layer 111′ and the margin portions 114′ and 115′ may have a composition the same as or similar to that of the cover portions 112 and 113. For example, in the dielectric layer 111′ and the margin portions 114′ and 115′, the number of moles of Dy based on 100 moles of Ti may be 3.7 to 4.5. In addition, in the dielectric layer 111′ and the margin portions 114′ and 115′, based on 100 moles of Ti, the number of Dy may be 3.7 to 4.5, the number of moles of Mg may be 0.18 to 0.22, the number of moles of Mn may be 0.225 to 0.275, and the number of moles of Si may be 1.17 to 1.43. Also, the dielectric layer 111′ and margin portions 114′ and 115′ may further include Ba as an additive, and the number of moles of Ba based on 100 mols of Ti may be 0.63 to 0.77.

In an embodiment, the outer margin portions 114b′ and 115b′ may include a region in which the standard deviation of the grain size is twice or more that of the inner margin portions 114a′ and 115a′. Accordingly, the moisture resistance reliability of the multilayer electronic component may be further improved.

Here, the outer margin portions 114b′ and 115b′ may include grains having a grain size of 1150 nm or greater.

In an embodiment, a region within 20 μm of the capacitance formation portion in the margin portions 114′ and 115′ may have a standard deviation of grain size that is twice or more that of a region within 20 μm of an outer surface of the margin portion in the margin portions 114′ and 115′.

In an embodiment, the standard deviation of grain sizes in the inner margin portions 114a′ and 115a′ may be 130 nm or less.

In an embodiment, the standard deviation of grain sizes in the outer margin portions 114b′ and 115b′ may be 260 nm or more.

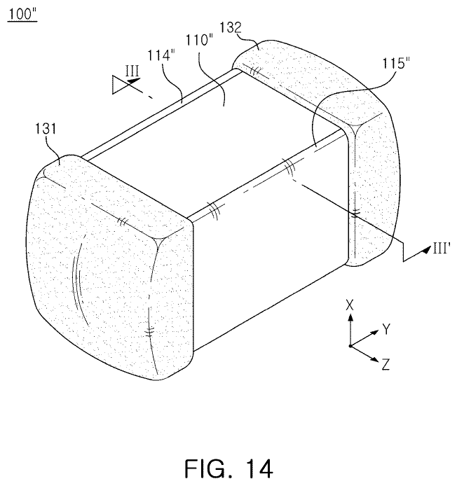

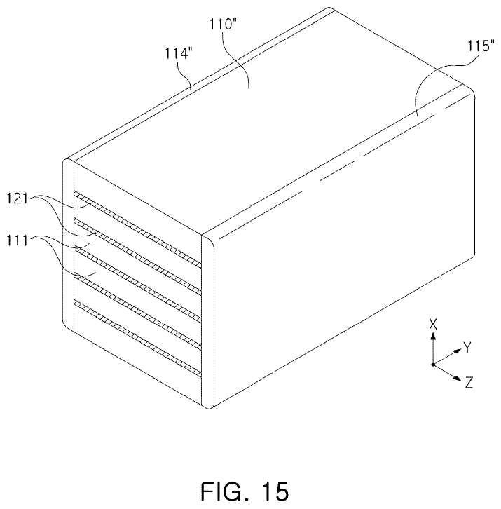

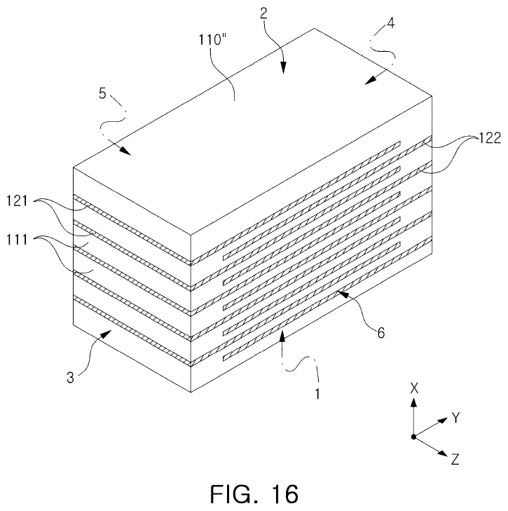

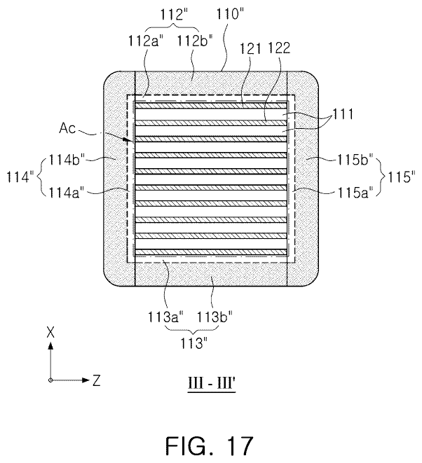

FIG. 14 is a perspective view schematically illustrating a multilayer electronic component according to a second embodiment of the present disclosure. FIG. 15 is a schematic illustration excluding external electrodes in FIG. 14. FIG. 16 is a schematic illustration excluding margin portions in FIG. 15. FIG. 17 is a cross-sectional view taken along line III-III′ of FIG. 14.

Referring to FIGS. 14 to 17, a multilayer electronic component 100″ according to the second embodiment of the present disclosure includes margin portions 114″ and 115″ disposed on both widthwise surfaces of the capacitance formation portion Ac. The margin portions 114″ and 115″ may include inner margin portions 114a″ and 115a″ adjacent to the capacitance formation portion and outer margin portions 114b″ and 115b″ adjacent to an outer surface of the margin portion.

In an embodiment, the inner margin portions 114a″ and 115a″ may include a plurality of first grains G1, and the outer margin portions 114b″ and 115b″ may each include a plurality of first grains G1 and a plurality of second grains G2. Accordingly, the moisture resistance reliability of the multilayer electronic component may be further improved.

In the multilayer electronic component 100″ according to the second embodiment of the present disclosure, in order to suppress a step difference due to the internal electrodes 121 and 122, after stacking, the internal electrodes may be cut to be exposed to the fifth and sixth surfaces 5 and 6 of the body 110″, and then a single dielectric layer or two or more dielectric layers may be stacking on both sides of the capacitance formation portion Ac in the third direction (width direction) to form the margin portions 114″ and 115″. Here, the first internal electrode 121 may be exposed to the third, fifth, and sixth surfaces of the body 110″, and the second internal electrode 122 may be exposed to the fourth, fifth, and sixth surfaces of the body 110″.

The cover portions 112″ and 113″ include inner cover portions 112a″ and 113a″ and outer cover portions 112b″ and 113b″ and include the features of the embodiments described above. However, unlike the embodiments described above, both widthwise surfaces of the cover portions 112″ and 113″ may be covered by the margin portions 114″ and 115″.

Here, the inner margin portions 114a″ and 115a″ may have an average grain size of 300 nm or less. In addition, an average width ratio of the outer margin portions 114b″ and 115b″ to an average width of the margin portions 114″ and 115″ may be 50% or more and 80% or less.

The margin portions 114″ and 115″ may be formed by stacking ceramic green sheets having the same composition as that of the ceramic green sheets used to form the cover portions 112″ and 113″ on the fifth and sixth surfaces of the body 110″ in the width direction. In this case, the margin portions 114″ and 115″ may have a composition the same as or similar to that of the cover portions 112″ and 113″. For example, in the margin portions 114″ and 115″, the number of moles of Dy based on 100 moles of Ti may be 3.7 to 4.5. In addition, in the margin portions 114″ and 115″, based on 100 moles of Ti, the number of moles of Dy may be 3.7 to 4.5, the number of moles of Mg may be 0.18 to 0.22, the number of moles of Mn may be 0.225 to 0.275, and the number of moles of Si may be 1.17 to 1.43. Also, the margin portions 114″ and 115″ may further include Ba as an additive, and the number of moles of Ba added as an additive based on 100 mols of Ti may be 0.63 to 0.77.

The dielectric layer 111″ may have a composition different from that of the margin portions 114″ and 115″ and the cover portions 112″ and 113″.

For example, in each of the margin portions 114″ and 115″ and the cover portions 112″ and 113″, the number of moles of Dy based on 100 moles of Ti may be 3.7 to 4.5, while, in the dielectric layer 111″, the number of moles of Dy based on 100 moles of Ti may be less than 3.7. While a large amount of Dy may decrease the capacitance, according to the present embodiment, the Dy content in the dielectric layer 111″ may be reduced to further improve the capacitance of the multilayer electronic component.

In order to make the dielectric layer 111″ have a different composition from those of the margin portions 114″ and 115″ and the cover portions 112″ and 113″, the dielectric layer 111″ may be formed using a ceramic green sheet having a different composition from that of the ceramic green sheet used to form the margin portions 114″ and 115″ and the cover portions 112″ and 113″. In this case, since the shrinkage ratios of the dielectric layer 111″ and the margin portions 114″ and 115″ and the cover portions 112″ and 113″ are different, a chip may have a convex shape or a concave shape. In this case, by further incorporating Ga into the ceramic green sheet for forming the margin portions 114″ and 115″ and the cover portions 112″ and 113″, the chip may be suppressed from having a convex or concave shape. Therefore, in an embodiment, the margin portions 114″ and 115″ and the cover portions 112″ and 113″ may further include Ga.

In an embodiment, the outer margin portions 114b″ and 115b″ may include a region in which the standard deviation of the grain size is twice or more that of the inner margin portions 114a″ and 115a″. Accordingly, the moisture resistance reliability of the multilayer electronic component may be further improved.

In an embodiment, a region within 20 μm of the capacitance formation region in the margin regions 114″ and 115″ may have a standard deviation of grain size that is twice or more that of a region within 20 μm of the outer surface of the margin region in the margin regions 114″ and 115″.

In an embodiment, the standard deviation of the grain size in the region within 20 μm of the capacitance forming region among the margin portions 114″ and 115″ may be twice or more that of the region within 20 μm of the outer surface of the margin portions 114″ and 115″.

In an embodiment, the standard deviation of the grain size in the inner margin portions 114a″ and 115a″ may be 130 nm or less.

In an embodiment, the standard deviation of the grain size in the outer margin portions 114b″ and 115b″ may be 260 nm or more.

### Experimental Example

A ceramic slurry including BaTiO₃ powder, an organic solvent, a binder, and an additive was prepared, and the slurry was applied onto a carrier film and dried to produce a ceramic green sheet. As additives, 0.2 mol of Mg, 4.1 mol of Dy, 0.25 mol of Mn, 0.7 mol of Ba, and 1.3 mol of Si, based on 100 moles of Ti in the BaTiO₃ powder, were added.

A paste for internal electrodes was applied onto the ceramic green sheet and then stacked to form a capacitance formation portion, and the ceramic green sheet was then stacked above and below the capacitance formation portion to form a stack.

The stack was cut to a predetermined chip size, and the cut chip were fired to form the body 110. Next, the external electrodes 131 and 132 were formed to produce a sample chip.

Here, the sintering temperature and time were adjusted so that the ratio (tco/tc) of the average thickness tco of the outer cover portions to the average thickness tc of the cover portions 112 and 113 satisfied Table 2 below.

For moisture resistance reliability, 400 sample chips for each Test No. were mounted on a PCB, and a voltage of 150 V was applied for 15 hours under conditions of temperature of 85° C. and humidity of 85%. Samples with an insulation resistance of 10 KΩ or less were determined as defective, and the number of defective samples was recorded.

The capacitance was measured for 10 sample chips for each Test No. The capacitance was measured under the conditions of an AC voltage of 1 Vrms and 1 kHz using an LCR meter, and the average value for each Test No. was obtained. The capacitance of Test No. 6 was set as a reference value of “100%,” and the values for tests 1 through 5 are relative to the capacitance of Test No. 5.

TABLE 2

| | | Moisture | |
|---|---|---|---|
| | | resistance | |
| Test No. | tco/tc | reliability | Capacitance |
| 1 | 90% | 0/400 | 89% |
| 2 | 80% | 0/400 | 94% |
| 3 | 70% | 0/400 | 94% |
| 4 | 50% | 1/400 | 95% |
| 5 | 30% | 7/400 | 98% |
| 6 | 10% | 8/400 | 100% |

In Test Nos. 2 to 4, in which the ratio (tco/tc) of the average thickness tco of the outer cover portion to the average thickness tc of the cover portions 112 and 113 was 50% to 80%, excellent moisture resistance reliability was achieved, while a capacitance reduction was suppressed.

In contrast, in Test No. 1, in which the ratio (tco/tc) of the average thickness tco of the outer cover portion to the average thickness tc of the cover portions 112 and 113 was 90%, it can be seen that the capacitance was 89% of that of Test No. 6, indicating a slight decrease in capacitance.

In addition, in Test Nos. 5 and 6, in which the ratio (tco/tc) of the average thickness tco of the outer cover portion to the average thickness tc of the cover portions 112 and 113 was 30% or less, it can be seen that the effect of improving moisture resistance reliability was relatively inferior to those of Test Nos. 1 to 4.

As one of various effects of the present disclosure, by controlling the size of grains of the inner and outer covers, the multilayer electronic component with improved reliability may be provided.

As one of various effects of the present disclosure, the multilayer electronic component with excellent capacitance per unit volume may be provided.

As one of various effects 41 the present disclosure, the multilayer electronic component with suppressed delamination or cracking at the interface between the cover portion and the capacitance formation portion may be provided.

However, the various advantages and effects of the present disclosure are not limited to the above-described contents and will be more readily understood when describing specific embodiments of the present disclosure.

Although the embodiments of the present disclosure have been described in detail above, the present disclosure is not limited to the embodiments described above and the accompanying drawings, but is intended to be limited by the appended claims. Accordingly, various forms of substitution, modification, and change may be made by those skilled in the art within the scope without departing from the technical idea of the present disclosure described in the claims, and this will also be considered to fall within the scope of the present disclosure.

The expression “an embodiment or an example” used in the present disclosure does not refer to identical examples and is provided to stress different unique features between each of the examples. However, examples provided in the following description are not excluded from being associated with features of other examples and implemented thereafter. For example, even if matters described in a specific example are not described in a different example thereto, the matters may be understood as being related to the other example, unless otherwise mentioned in descriptions thereof.

The terms used herein are for the purpose of describing particular embodiments only and are not intended to limit the embodiments. As used herein, the singular forms “a,” “an,” and “the” are intended to include the plural forms as well, unless the context clearly indicates otherwise.

What is claimed is:

1. A multilayer electronic component comprising:
a body including a capacitance formation portion including a dielectric layer and internal electrodes arranged alternately with the dielectric layer in a thickness direction and a cover portion disposed above and below the capacitance formation portion in the thickness direction; and
an external electrode disposed on the body,
wherein the cover portion includes an inner cover portion adjacent to the capacitance formation portion and an outer cover portion adjacent to an outer surface of the cover portion, and
wherein, when an average value of a major axis length and a minor axis length of grains is defined as grain size,
the inner cover portion includes a plurality of first grains having a grain size of 500 nm or less, and
the outer cover portion includes a plurality of first grains and a plurality of second grains of a grain size of 1150 nm or more.

2. The multilayer electronic component of claim 1, wherein the inner cover portion has an average grain size of 300 nm or less.

3. The multilayer electronic component of claim 1, wherein the outer cover portion includes a region in which a standard deviation of the grain size is twice or more that of the inner cover portion.

4. The multilayer electronic component of claim 1, wherein the inner cover portion has a standard deviation of grain size of 130 nm or less.

5. The multilayer electronic component of claim 1, wherein the outer cover portion has a standard deviation of grain size of 260 nm or more.

6. The multilayer electronic component of claim 1, wherein a maximum size of the grains included in the inner cover portion is 1100 nm or less.

7. The multilayer electronic component of claim 1, wherein a maximum size of the grains included in the outer cover portion is 2300 nm or more.

8. The multilayer electronic component of claim 1, wherein, in a cross-section of the outer cover portion in thickness and width directions, a ratio of an area of the plurality of second grains to an area of the outer cover portion is 50% or more and 95% or less.

9. The multilayer electronic component of claim 1, wherein, in a cross-section of the inner cover portion in the thickness and width directions, a ratio of an area occupied by the first grains relative to an area of the inner cover portion is 90% or more.

10. The multilayer electronic component of claim 1, wherein a ratio of an average thickness of the outer cover portion to an average thickness of the cover portion is 50% or more and 80% or less.

11. The multilayer electronic component of claim 1, wherein a number of moles of Dy included in the cover portion, based on 100 moles of Ti, is 3.7 to 4.5.

12. The multilayer electronic component of claim 1, wherein, in the cover portion, based on 100 moles of Ti, a number of moles of Dy is 3.7 to 4.5, a number of moles of Mg is 0.18 to 0.22, a number of moles of Mn is 0.225 to 0.275, and a number of moles of Si is 1.17 to 1.43.

13. The multilayer electronic component of claim 1, wherein the dielectric layer includes a plurality of the first grains, and an average value of grain sizes is 300 nm or less.

14. The multilayer electronic component of claim 1, wherein a number of moles of Dy included in the dielectric layer, based on 100 moles of Ti, is 3.7 to 4.5.

15. The multilayer electronic component of claim 1, wherein, in the dielectric layer, based on 100 moles of Ti, a number of moles of Dy is 3.7 to 4.5, a number of moles of Mg is 0.18 to 0.22, a number of moles of Mn is 0.225 to 0.275, and a number of moles of Si is 1.17 to 1.43.

16. The multilayer electronic component of claim 1, further comprising:
a margin portion on both sides of the capacitance formation portion in a width direction,
wherein the margin portion includes an inner margin portion adjacent to the capacitance formation portion and an outer margin portion adjacent to an outer surface of the margin portion,
the inner margin portion includes a plurality of the first grains, and
the outer margin portion includes each of a plurality of the first grains and a plurality of the second grains.

17. The multilayer electronic component of claim 16, wherein the inner margin portion has an average grain size of 300 nm or less.

18. The multilayer electronic component of claim 16, wherein a ratio of an average width of the outer margin portion to an average width of the margin portion is 50% or more and 80% or less.

19. The multilayer electronic component of claim 16, wherein, in each of the cover portion and the margin portion, a number of moles of Dy based on 100 moles of Ti is 3.7 to 4.5, and in the dielectric layer, a number of moles of Dy based on 100 moles of Ti is less than 3.7.

20. The multilayer electronic component of claim 19, wherein the cover portion and margin portion further include Ga.

21. A multilayer electronic component comprising:
a body including a capacitance formation portion including a dielectric layer and internal electrodes arranged alternately with the dielectric layer in a thickness direction and a cover portion disposed above and below the capacitance formation portion in the thickness direction; and
an external electrode disposed on the body,
wherein the cover portion includes an inner cover portion adjacent to the capacitance formation portion and an outer cover portion adjacent to an outer surface of the cover portion, and
when an average value of a major axis length and a minor axis length of a grain is defined as grain size, the outer cover portion includes a region in which a standard deviation of the grain size is twice or more that of the inner cover portion.

22. The multilayer electronic component of claim 21, wherein a standard deviation of the grain size in a region of the cover portion within 20 μm of the capacitance formation portion is twice or more that of a region of the cover portion within 20 μm of an outer surface of the cover portion.

23. The multilayer electronic component of claim 21, wherein the inner cover portion has a standard deviation of grain size of 130 nm or less.

24. The multilayer electronic component of claim 21, wherein the outer cover portion has a standard deviation of grain size of 260 nm or more.

25. The multilayer electronic component of claim 21, wherein the outer cover portion includes grains having a grain size of 1150 nm or more.

26. The multilayer electronic component of claim 21, wherein the inner cover portion has an average grain size of 300 nm or less.

27. The multilayer electronic component of claim 21, wherein an average thickness ratio of the outer cover portion to an average thickness of the cover portion is 50% or more and 80% or less.

28. The multilayer electronic component of claim 21, wherein, in the cover portion, a number of moles of Dy based on 100 moles of Ti is 3.7 to 4.5.

29. The multilayer electronic component of claim 21, further comprising:
a margin portion on both sides of the capacitance formation portion in a width direction,
wherein the margin portion includes an inner margin portion adjacent to the capacitance formation portion and an outer margin portion adjacent to an outer surface of the margin portion, and
the outer margin portion includes a region in which a standard deviation of the grain size is twice or more that of the inner margin portion.

30. The multilayer electronic component of claim 29, wherein the standard deviation of the grain size in a region of the margin portion within 20 μm of the capacitance formation portion is twice or more that of a region of the margin portion within 20 μm of an outer surface of the margin portion.

31. The multilayer electronic component of claim 29, wherein a ratio of an average width of the outer margin portion to an average width of the margin portion is 50% or more and 80% or less.

32. A multilayer electronic component, comprising:
a capacitance forming portion comprising first and second internal electrodes stacked in a thickness direction with a dielectric layer interposed therebetween; and
top and bottom cover portions, disposed above and below the capacitance forming portion in the thickness direction, each of the top and bottom cover portions comprising:
an inner cover portion disposed to be in contact with the capacitance forming portion and including first dielectric grains having a first average grain size, and
an outer cover portion disposed on the inner cover portion and away from the capacitance forming portion in the thickness direction, and including the first dielectric grains and second dielectric grains having a second average grain size,
wherein a ratio of first average grain size to second average grain size is greater than 2.0,
wherein a ratio of an average thickness of the outer cover portion to an average thickness of the cover portion is 50% or more and 80% or less, and
a number of moles of Dy included in the cover portion, based on 100 moles of Ti, is 3.7 to 4.5.

33. The multilayer ceramic capacitor of claim 32, wherein the first average grain size is 500 nm or less and the second average grain size is 1150 nm or more.

34. The multilayer ceramic capacitor of claim 32, wherein a standard deviation of grain sizes in at least a region of the outer cover portion is twice or more greater than a standard deviation of grain sizes in the inner cover portion.

35. The multilayer ceramic capacitor of claim 32, wherein, in the cover portion, a number of moles of Mg is 0.18 to 0.22, a number of moles of Mn is 0.225 to 0.275, and a number of moles of Si is 1.17 to 1.43, for every 100 moles of Ti.

36. The multilayer ceramic capacitor of claim 32, further comprising:
margin portions disposed on both sides of the capacitance forming portion in a width direction, each of the margin portions comprising:
an inner margin portion disposed to be in contact with the capacitance forming portion and including first dielectric grains, and
an outer margin portion disposed on the inner margin portion and away from the capacitance forming portion in the width direction, and including the first dielectric grains and the second dielectric grains.

37. The multilayer ceramic capacitor of claim 36, wherein a ratio of an average dimension of the outer margin portion in the width direction to an average dimension of the inner margin portion in the width direction is in a range from 0.5 to 0.8.
